(19) United States
(12) Patent Application Publication
(10) Pub. No.: US 2008/0134734 A1
(43) Pub. Date: Jun. 12, 2008

(54) Opening and closing apparatus

(76) Inventor: Kyeong Ho Lee, Hwaseong-city (KR)

Correspondence Address: MORGAN, LEWIS & BOCKIUS LLP (SF), One Market, Spear Street Tower, Suite 2800, San Francisco, CA, 94105, US

(21) Appl. No.: 11/733,000

(22) Filed: Apr. 5, 2007

(30) Foreign Application Priority Data
Dec. 6, 2006 (KR) 10-2006-0123298

(51) Int. Cl. E05B 13/10

(52) U.S. Cl. 70/208

(57) ABSTRACT

An opening and closing apparatus of a luggage compartment door of a vehicle includes: a case mounted to the door; a handle in the case; a rod connected to the handle; a first plate mounted to the case, and rotatable in response to movement of the rod; a first link, movable in response to rotation of the first plate to unlatch the door; and a keyhole in the case. The keyhole is rotatable between a locked state, in which the handle cannot move the rod, and an unlocked state, in which the handle can move the rod.

### CROSS-REFERENCE TO RELATED APPLICATION

This application claims priority to, and the benefit of, Korean Patent Application No. 10-2006-0123298, filed in the Korean Intellectual Property Office on Dec. 6, 2006, the entire contents of which are incorporated herein by reference.

### BACKGROUND OF THE INVENTION

(a) Field of the Invention

The present invention relates to an opening and closing apparatus of a door of a vehicle luggage compartment.

(b) Description of the Related Art

Typically, large vehicles, such as buses, have luggage compartments at lower ends thereof. The door of such a compartment typically includes a handle, which, when pulled, rotates a hook, which turn pulls a rod. The rod rotates a series of plates, with pull secondary rods, releasing them from a latched state to open the door.

A keyhole is provided some distance away from the handle. When a key is rotated within the keyhole, it pulls yet another rod to lock the plates together, locking the door.

Because the keyhole and handle are separate, the door may deform during manufacturing, and water may permeate the handle or keyhole structure. In addition, because of the numerous components, manufacturing cost and time are high.

The above information disclosed in this Background section is only for enhancement of understanding of the background of the invention and therefore it may contain information that does not form the prior art that is already known in this country to a person of ordinary skill in the art.

### SUMMARY OF THE INVENTION

Exemplary embodiments of the present invention provide an opening and closing apparatus of a luggage compartment door of a vehicle, including: a case mounted to the door; a handle in the case; a rod connected to the handle; a first plate mounted to the case, and rotatable in response to movement of the rod; a first link, movable in response to rotation of the first plate to unlatch the door; and a keyhole in the case. The keyhole is rotatable between a locked state, in which the handle cannot move the rod, and an unlocked state, in which the handle can move the rod.

The apparatus may further include a second plate engaged to gear teeth on the first plate such that the second plate rotates in response to the rotation of the first plate. A second link is movable by rotation of the second plate to unlatch the door.

The apparatus may further include a slider, slidable in response to rotation of the keyhole, and blocking motion of the handle when the keyhole is in the locked state.

### BRIEF DESCRIPTION OF THE DRAWINGS

FIG. 1 is a perspective view of an exterior surface of an opening and closing apparatus according to an exemplary embodiment of the present invention.

FIG. 2 is a perspective view of an interior surface of the apparatus of FIG. 1.

FIG. 3 is a view similar to FIG. 2, illustrating operation of the apparatus.

FIG. 4 is a view similar to FIGS. 2 and 3, illustrating operation of a keyhole.

### DESCRIPTION OF REFERENCE NUMERALS INDICATING PRIMARY ELEMENTS IN THE DRAWINGS

200: door
201: handle
202: stick
203: keyhole
205: case
207: first link
209: second link
301: rod
303: first plate
305: slot
307: slider
309: second plate

### DETAILED DESCRIPTION OF THE PREFERRED EMBODIMENTS

An exemplary embodiment of the present invention will hereinafter be described in detail with reference to the accompanying drawings.

According to an exemplary embodiment of the present invention, an opening and closing apparatus of a luggage compartment door 200 of a vehicle includes a case 205 mounted to the door 200, and a handle 201 in the case 205. The handle 201 moves a rod 301. A keyhole 203 is also disposed in the case 205, and rotates to selectively block operation of the handle 201.

A first plate 303 is rotatably secured to the case 205 and selectively rotated by the rod 301. When the first plate 303 rotates, it pulls a first link 207, which opens the door 200.

Since the case 205 houses the handle 201 and the keyhole 203, water permeation to the handle 201 and the keyhole 203 is prevented. In addition, because the case 205 is firstly mounted to the door 200, manufacturing efficiency is improved.

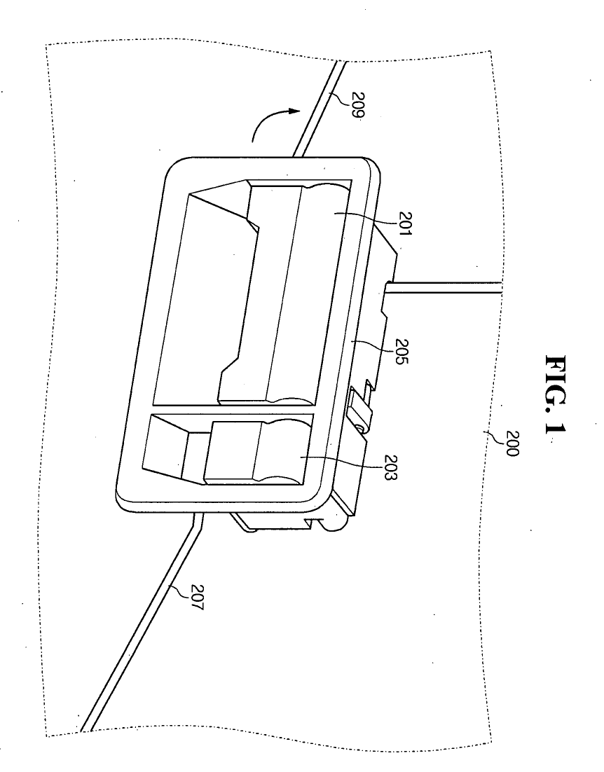

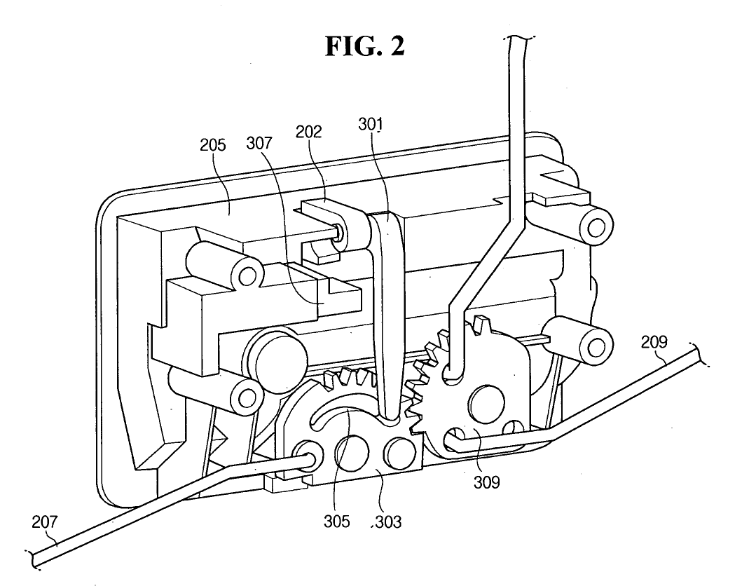

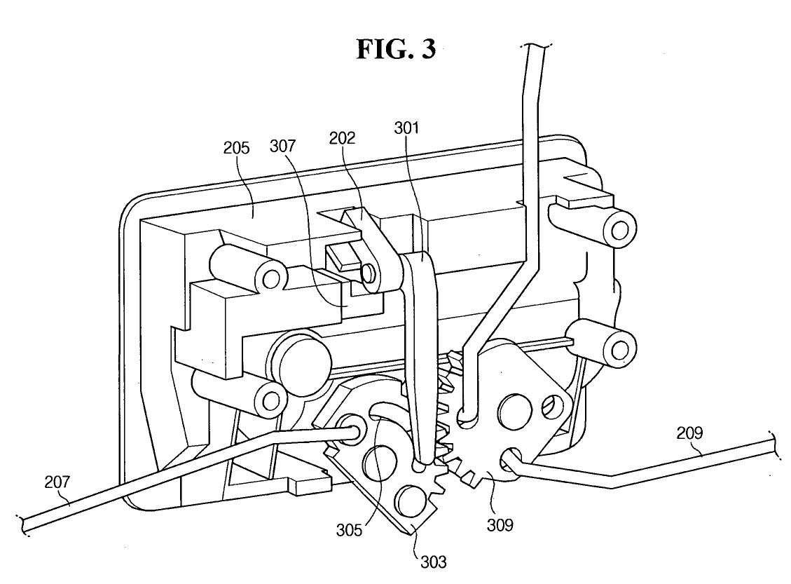

When the handle 201 moves in the direction of the arrow in FIG. 1, and referring also to FIGS. 2 and 3, a stick 202, which is integral to the handle 201, moves downward in the drawings. The rod 301 then moves downward within a slot 305 of the first plate 303, and the first plate 303 rotates clockwise.

As shown in FIG. 2 to FIG. 4, gear teeth are provided on the first plate 303. A second plate 309 is engaged to the gear teeth such that when the first plate 303 rotates clockwise, the second plate 309 rotates counterclockwise. The first link 207 and the second link 209 are pulled by the first plate 303 and the second plate 309, respectively. The motion of the first and second links 207, 209 unlatches a latching mechanism, which may be designed and implemented by a person of ordinary skill in the art based on the teachings herein.

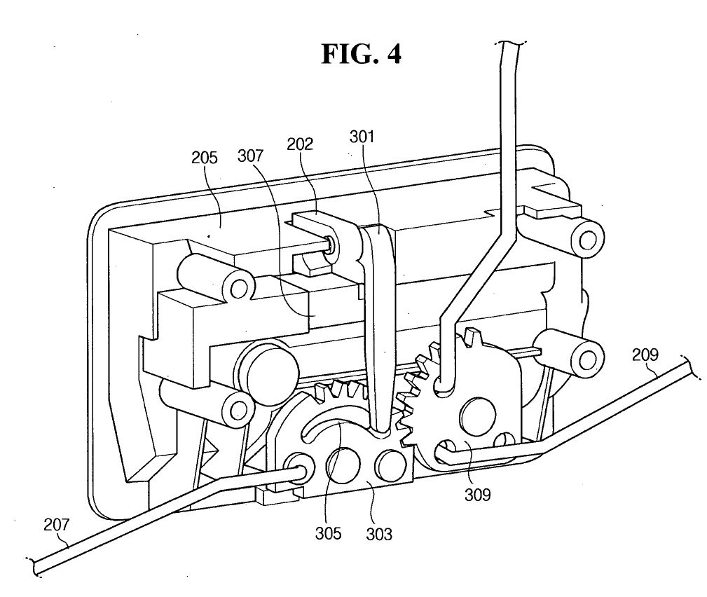

Referring to FIG. 4, if a key (not shown) is rotated in the keyhole 203, a slider 307 moves rightwards in the drawing, blocking movement of the stick 202 such that the opening and closing apparatus cannot open the door 200.

According to an exemplary embodiment of the present invention, because the keyhole and the handle are mounted together in the case, the water permeation and deformation of the door are prevented. In addition, because the number of components is low, manufacturing cost and time are reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An opening and closing apparatus of a luggage compartment door of a vehicle, comprising:
a case mounted to the door;
a handle disposed in the case;
a rod connected to the handle;
a first plate mounted to the case, and rotatable in response to movement of the rod;
a first link, movable in response to rotation of the first plate to unlatch the door; and
a keyhole disposed in the case and rotatable between a locked state, in which the handle cannot move the rod, and an unlocked state, in which the handle can move the rod.

2. The apparatus of claim 1, further comprising a second plate engaged to gear teeth on the first plate such that the second plate rotates in response to the rotation of the first plate.

3. The apparatus of claim 2, further comprising a second link, movable by rotation of the second plate to unlatch the door.

4. The apparatus of claim 1, further comprising a slider, slidable in response to rotation of the keyhole, and blocking motion of the handle when the keyhole is in the locked state.
